(19) United States
(12) Patent Application Publication
(10) Pub. No.: US 2016/0309310 A1
(43) Pub. Date: Oct. 20, 2016

(54) SYSTEM AND METHOD FOR PROVIDING AN INTELLIGENT REMINDER FOR COMMENCING A LIVE COMMUNICATIONS SESSION

(71) Applicant: Cyanogen Inc., Palo Alto, CA (US)

(72) Inventors: David Herman, Seattle, WA (US); Fan Zhang, Bellevue, WA (US)

(21) Appl. No.: 14/687,356

(22) Filed: Apr. 15, 2015

(51) Int. Cl. H04W 4/16; H04W 68/00

(52) U.S. Cl. CPC H04W 4/16; H04W 68/005

(57) ABSTRACT

A method and system for providing an intelligent reminder by a device after a failed call. The system detects that a call was commenced but not connected with a called party. The system creates an intelligent reminder and, when it is triggered, generates an alert via a user device. An intelligent reminder is triggered when the system identifies that a trigger condition for the intelligent reminder has been met. The alert includes an option to commence a call with the called party. A user may quickly and easily commence a call with the called party via the option included in the alert.

### BACKGROUND

People communicate electronically under varying degrees of urgency. A user placing a voice call typically wishes to communicate immediately with a called party. However, a voice call is often not connected successfully because the called party either misses or ignores the call. After a failed call, either one of the called or calling parties may wish to commence a follow-up call at a later time.

Despite wishing to connect with the other party, each may forget to commence a subsequent call. Either of these parties could create a reminder to call the other. For example, the called party could schedule a reminder on a calendar application to return the call at a particular time. Unfortunately, conventional reminders are rigid in their execution. If the user is not accurate in selecting a time that is ultimately convenient to commence a call, the user may be reminded at a time that will not result in the user commencing a call. As a consequence, the user may ultimately forget to call the other party.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a suitable environment in which a system for providing an intelligent reminder for commencing a live communications session with a called party may operate.

FIG. 2 is a simplified system block diagram of hardware components of a touch-sensitive device for implementing a system for providing an intelligent reminder.

FIG. 3 is a system diagram showing components of a system for providing an intelligent reminder.

FIG. 4 is flow diagram depicting a method performed by the system for creating an intelligent reminder after a live communications session commenced by a user has failed, and for generating an alert associated with the intelligent reminder.

FIG. 5A is a representative interface generated by the system for receiving input from a user for creating an intelligent reminder.

FIG. 5B is a representative interface generated by the system for an alert for an intelligent reminder, enabling a user to quickly commence a call to a called party.

FIG. 6 is a flow diagram depicting a method performed by the system for creating an intelligent reminder after a live communications session commenced by a calling party has failed, and for generating an alert associated with the intelligent reminder.

FIG. 7 is a representative interface generated by the system for receiving an incoming call.

FIG. 8 is a flow diagram depicting a method performed by the system for identifying candidate trigger conditions for an intelligent reminder.

FIG. 9 is a table including intelligent reminders and associated trigger conditions.

### DETAILED DESCRIPTION

A method and system are described for providing an intelligent reminder by a device after a failed live communications session. The system detects that a live communications session—discussed generally throughout as a “call”—was commenced but that the call was not established. The system creates an intelligent reminder that, when triggered, reminds a user to commence a subsequent call with the other party to the failed call and provides an interface for quickly commencing the call.

The system can create an intelligent reminder for reminding a user to commence a second call to a called party after a first call commenced by the user has failed to connect. Similarly, the system can create an intelligent reminder for reminding a user to commence a return call to a calling party after a first call initiated by the calling party has failed to connect. An intelligent reminder is triggered when the system identifies a condition satisfying a trigger condition associated with the intelligent reminder. A trigger condition can identify a geographic location of a device, an event attended by the user, a status of the device, a time, a time period, a network sensed by or connected to by the device, another device sensed or connected to by the device, a velocity and/or acceleration of the device, or other conditions. When a trigger condition is identified, the system generates an alert including a reminder to commence a call to the party to the call.

The system can automatically create an intelligent reminder and cause a trigger condition to be associated with it after a call has failed. For example, after detecting that a received call has failed to connect with a user, the system may automatically create an intelligent reminder including a trigger condition to remind the user to commence a return call when the user returns home. A trigger condition can be identified by comparing a property associated with the user, such as a geographic location, to a known value of the property when the user is typically willing to commence a call. If, for example, the system identifies that a user is not at his or her home when a call failed to connect, the system may determine to associate a trigger condition with an intelligent reminder that is triggered when the user is identified as being home. In some implementations, the system creates an intelligent reminder after receiving an instruction from a user to do so. The system may also receive a selection by a user of a trigger condition that is to be associated with the intelligent reminder.

When an intelligent reminder is active, the system monitors for a trigger condition associated with the intelligent reminder. When the trigger condition is identified, the system generates an alert, including an option to commence a call to the other party to the earlier call. The alert can be audible (and a user's input audible as well) and/or the alert can be visual. The system may generate an interface to be displayed by the device for alerting the user of the reminder. If the user selects to commence a call to the other party, the system instructs an application used for calling the other party to commence a call.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of a system for providing intelligent reminders after a failed call. The system is described with respect to a number of processes that it may implement and numerous examples of how it may be implemented.

### Suitable Environments

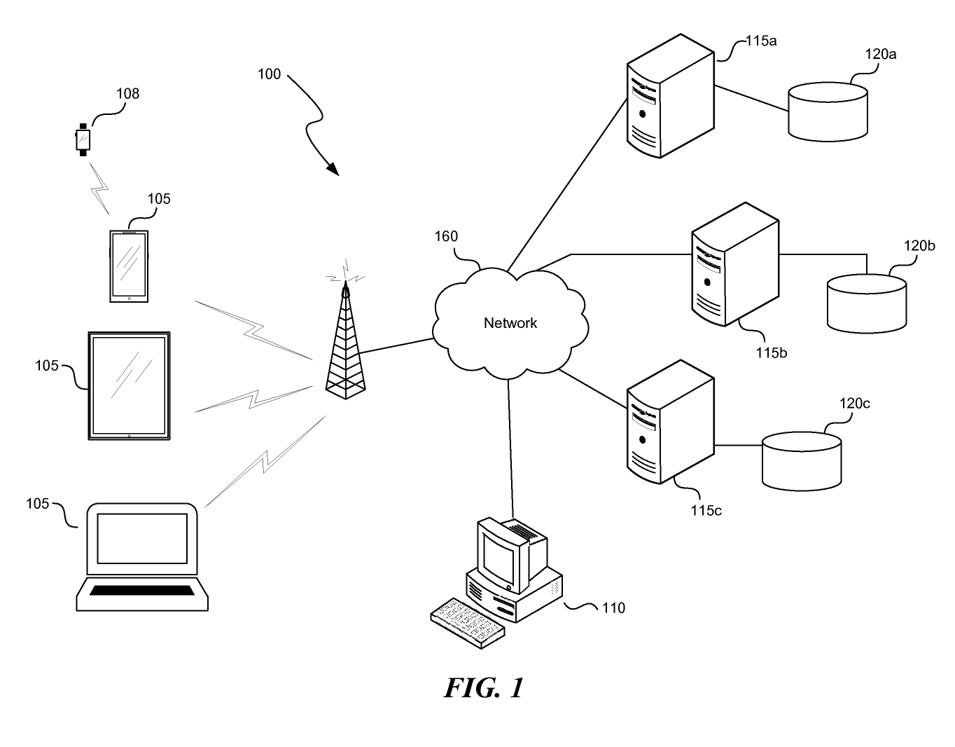

FIG. 1 and the following discussion provide a brief, general description of a suitable computing environment 100 in which a system for enabling secure streaming communications may be implemented. Although not required, aspects and implementations of the invention will be described in the general context of computer-executable instructions, such as routines executed by a general-purpose computer, a server computer, or other computing systems and devices. The invention can also be embodied in a special purpose computer or data processor that is specifically programmed, configured, or constructed to perform one or more of the computer-executable instructions explained in detail herein. Indeed, the terms “computer,” “computing device,” and “device” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network 160, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, and stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a system for providing an intelligent reminder according to embodiments of the invention operates in or among mobile devices 105 and/or a computer 110, or between a device and a server computer 115a-c, or a device and another type of device. The system can also operate in a wearable device 108 or among the wearable and a mobile device 105 or computer 110. For example, the system may cause an alert to be generated by a smartwatch for reminding a user to commence a call to another party, and a user wearing the smartwatch may commence a call via a mobile device. Mobile devices may include a smartphone, a tablet computer, a laptop computer, a vehicle computing device (e.g., a vehicle navigation system), and the like. The system may also be implemented for providing an intelligent reminder on a set top box, a media/gaming console, a smart appliance, or the like. The mobile devices 105 and personal computers 110 communicate through one or more wired or wireless networks 160 with the servers 115. Data storage areas 120a-c contain data utilized by the system, and, in some implementations, software necessary to perform functions of the system. For example, the data storage area 120a may contain trigger conditions that have been made to be associated with intelligent reminders for various users. As another example, the data storage area 120b may include call data and user data stored by a provider of a service used for calling a called party.

The mobile devices 105 and computer 110 communicate with each other and servers 115a-c through networks 160, including, for example, the Internet. The mobile devices 105 communicate wirelessly with a base station or access point using a wireless mobile telephone standard, such as the Global System for Mobile Communications (GSM), or another wireless standard, such as IEEE 802.11, and the base station or access point communicates with the servers 115a-c via the networks 160. The wearable device 108 communicates with via short range protocols, such as Bluetooth® with the mobile device 105. Computers 110 communicate through the networks 160 using, for example, TCP/IP protocols.

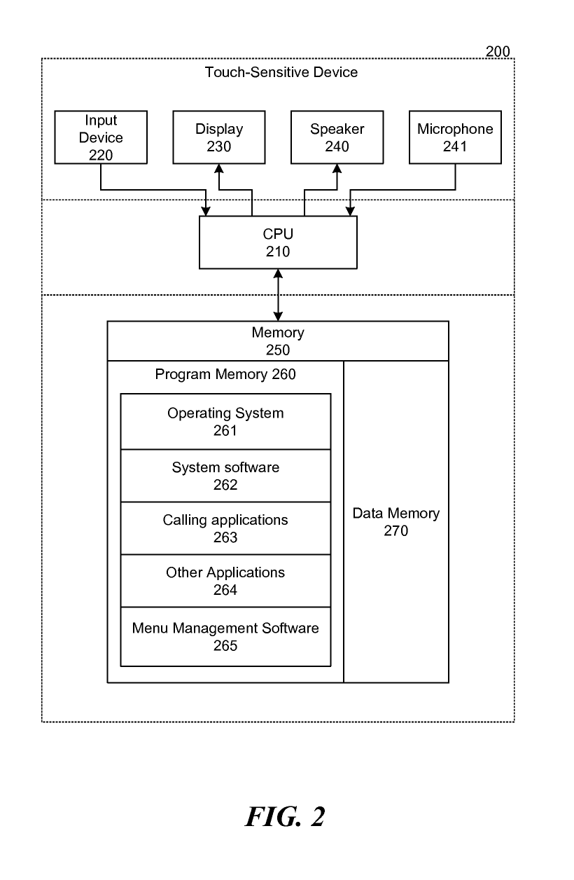

The system for providing an intelligent reminder may be implemented in a touch-sensitive device. For example, the system may be implemented in a mobile device 105. FIG. 2 is a simplified system block diagram of hardware components of a touch-sensitive device 200 for implementing a system for providing an intelligent reminder to call a called party. The device 200 includes one or more input devices 220 that provide input to the CPU (processor) 210, notifying it of actions performed by a user, such as a received touch and gesture from the user. The actions are typically mediated by a hardware controller that interprets the signals received from the input device and communicates the information to the CPU 210 using a known communication protocol. Input devices 220 include, for example, a capacitive touchscreen, a resistive touchscreen, a surface wave touchscreen, a surface capacitance touchscreen, a projected capacitive touch screen, a mutual capacitance touchscreen, a self-capacitance sensor, an infrared touchscreen, an infrared acrylic projection touchscreen, an optical imaging touchscreen, a touchpad that uses capacitive sensing or conductance sensing, or the like.

The CPU may be a single processing unit or multiple processing units in a device or distributed across multiple devices. Similarly, the CPU 210 communicates with a hardware controller for a display 230 on which text and graphics, such as a visual component of an alert for an intelligent reminder, are displayed. One example of a display 230 is a display of the touchscreen that provides graphical and textual visual feedback to a user. In some implementations, the display includes the input device as part of the display, such as when the input device is a touchscreen. In some implementations, the display is separate from the input device. For example, a touchpad (or trackpad) may be used as the input device 220, and a separate or standalone display device that is distinct from the input device 220 may be used as the display 230. Examples of standalone display devices are: an LCD display screen, an LED display screen, a projected display (such as a heads-up display device), and so on. A speaker 240 is also coupled to the processor so that any appropriate auditory signals can be passed on to the user. For example, a touch-sensitive device may generate audio for an alert associated with an intelligent reminder. The touch-sensitive device includes a microphone 241 that is also coupled to the processor so that spoken input can be received from the user. The microphone and speaker can also be used for facilitating a voice call. In some implementations, the touch-sensitive device includes an image sensor, which may be used for video calls.

The processor 210 has access to a memory 250, which may include a combination of temporary and/or permanent storage, and both read-only and writable memory (random access memory or RAM), read-only memory (ROM), writable non-volatile memory, such as flash memory, hard drives, floppy disks, and so forth. The memory 250 includes program memory 260 that contains all programs and software; programs and software include an operating system 261, system software 262 including software for implementing a system for providing an intelligent reminder as discussed herein, calling applications 263 (e.g., a dialer application for providing calls over a cellular service, a voice-over IP (VoIP) calling application), and any other application programs 264. The program memory 260 may also contain menu management software 265 for graphically displaying two or more choices of trigger conditions for a user and determining a selection by a user of one or more of the graphically displayed choices. The memory 250 also includes data memory 270 that includes any configuration data, settings, user options and preferences that may be needed by the program memory 260, or any element of the device 200.

The touch-sensitive device also includes a communication device capable of communicating wirelessly with a base station or access point using a wireless mobile telephone standard, such as the Global System for Mobile Communications (GSM), Long Term Evolution (LTE), IEEE 802.11, or another wireless standard. The communication device may also communicate with another device or a server through a network using, for example, TCP/IP protocols. For example, the touch-sensitive device may utilize the communication device to communicate with another device and to offload some processing operations to a more robust system or computer. The touch-sensitive device also includes motion sensors, such as accelerometers; environmental sensors, such as ambient air temperature; and position sensors, including orientation sensors. The touch-sensitive device also includes a Global Positioning System (GPS) receiver, and/or other sensors or modules for identifying a location of the device.

### Suitable Systems

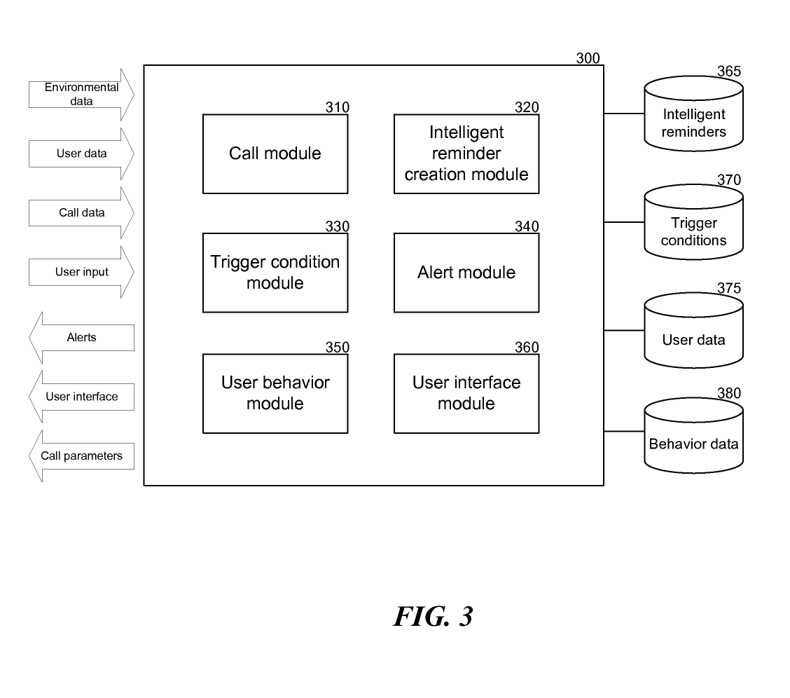

FIG. 3 is a block diagram of a system 300 for providing an intelligent reminder for commencing a call. The system can be implemented in, for example, a mobile device 105. The system generates an alert for an intelligent reminder, which may include a visual component for display by a device, either to remind the user to commence a second call to a called party after a first call commenced by the user has failed, or to remind the user to commence a return call after a first call commenced by a calling party has failed to be connected. The alert includes an interface for quickly commencing a call with the party to be called. The system includes a call module 310, an intelligent reminder creation module 320, a trigger condition module 330, an alert module 340, a user behavior module 350, and a user interface module 350. The system 300 stores data in and reads data from intelligent reminders data storage 365, trigger conditions data storage 370, user data storage 375, and behavior data storage 380. The system 300 identifies a failure to establish a call, creates an intelligent reminder, and generates an alert when the system identifies that a trigger condition associated with the intelligent reminder has been met. The call includes an audio call (e.g., a cellular telephone call, VoIP call), a video call, and the like.

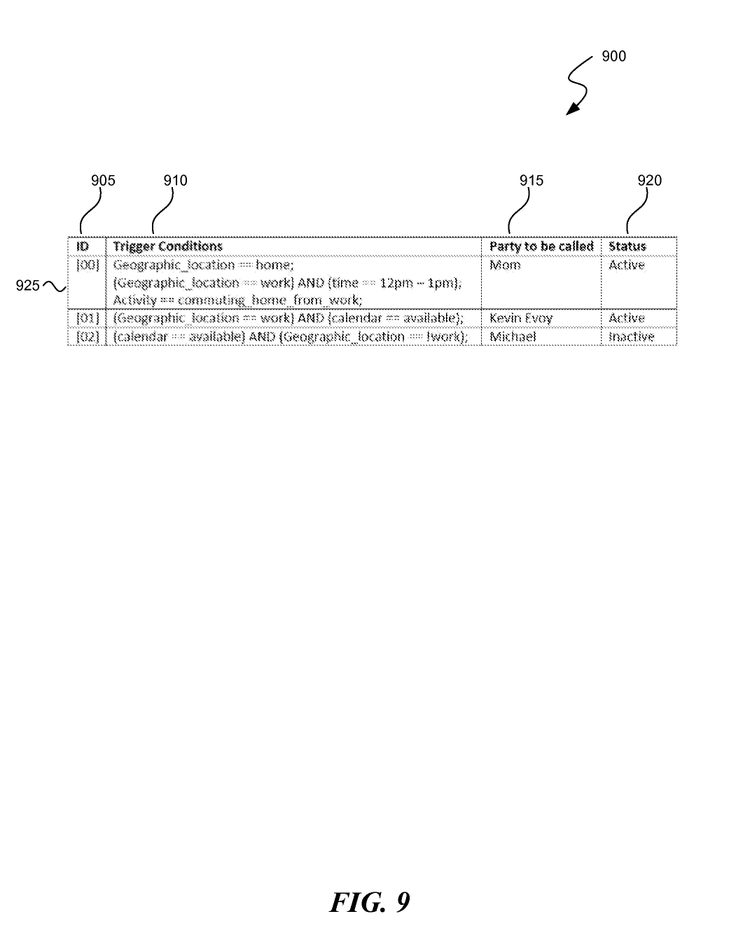

An intelligent reminder is associated with at least one trigger condition and a party to be called. The system 300 can maintain intelligent reminders, including trigger conditions and other associated data, in various data structures. FIG. 9 shows a table 900 representing data associated with illustrative intelligent reminders according to some implementations. The table 900 includes a reminder ID column 905, a trigger condition column 910, a party to be called column 915, and a status column 920. A trigger condition includes, for each intelligent reminder, at least one criterion that is to be met for triggering an alert associated with the intelligent reminder. Each criterion includes a property and a value associated with the property, and a criterion is met when the system observes the value for the property. The value may be associated with a condition that the system has determined is indicative of the user being available and/or willing to commence a call. In the example in the table 900, a first row 925 of the table 900 includes data for a first intelligent reminder. A criterion for a first trigger condition for the first intelligent reminder includes that a value, “home,” be observed for property, “Geographic_location.” Criteria for a second trigger condition for the first intelligent reminder includes that a value, “work,” be observed for property, “Geographic_location,” and a value, “12 pm-1 pm,” be observed for property, “time.” Considering that the first intelligent reminder 925 is associated with a status of “Active,” if the system determines that any of the three trigger conditions for the first intelligent reminder 925 is met, it generates an alert including an interface for quickly calling the party to be called for the first intelligent reminder (i.e., Mom). The party to be called may include a contact name, a contact number, a username, or the like, which can be used by an application for calling the party to be called.

The system 300 receives various input in order to create intelligent reminders and identify whether a trigger condition for an intelligent reminder has been met. The system receives environmental data, user data, device data, user input, and call data, and the system outputs alerts, user interfaces, and call parameters. Environmental data includes information associated with an environment of a device of a user. Environmental data can be captured by a sensor or received by a device from another device or system. For example, environmental data includes geographic location information for a device as determined by a GPS receiver of the device. Environmental data may also include audio captured by a microphone of a device and images captured by an image sensor of a device. Environmental data also includes data captured by an accelerometer, or data captured from an ambient light sensor, or the like. In some implementations, environmental data includes data associated with a party to be called, including geographic location information for a device associated with a party to be called. For example, the system may receive geographic coordinates determined by a device of a party to be called or other location information for the device.

User data includes data associated with and/or created by a user for whom the system creates an intelligent reminder. User data includes calendar information (e.g., scheduled events, reminders), demographic information (e.g., age, sex, nationality), location information (e.g., a home address, a work address), text-based messages sent or received by the user, web browsing history, social media data for the user, contacts information, and the like. User data includes stored and identified current values of a property associated with the user that the system stores for determining a willingness of the user to commence a call. The system identifies user data stored in a device of the user and in remote sources, such as third party servers associated with a social media application. User data is stored and accessed in user data storage 375. In some implementations, user data includes data associated with a party to be called. For example, user data may include calendar information for a party to be called, or demographic information for the party to be called. User data includes a relationship between a user and a contact. A relationship includes a familial relationship, a business relationship, or the like. A relationship may be identified in contact data stored on a device, in social media data, and similar sources, or inferred based on interaction between the user and the contact.

Call data includes data associated with calls that a user is a party to, including as a calling party and a called party. Call data includes data pertaining to a call that is ongoing and/or pending. Call data can also include data pertaining to previously established or attempted calls. Call data can be received from an application for commencing, receiving, and connecting calls. For example, call data can be received from a dialer application used for connecting cellular telephone calls. Call data can also be received from an application for connecting VoIP calls or video calls. In some implementations, call data is received from a service provider, such as a cellular service provider or from data maintained for an application by other entities.

Call data includes a call status. A status of a call includes whether a call is pending, connected, failed, or so forth. Call data includes a call timer, identifiers for parties connected to the call, and a time that a call was commenced. In some implementations, call data includes audio from the call. Call data can include an indication of whether a voicemail system has been accessed. In some implementations, call data includes a time zone or geographic location information of a called party and/or a calling party measured by a device during a call. Call data can also identify relationship information associated with a called party and a calling party. For example, call data can identify whether two parties are colleagues, relatives, friends, and so forth.

User input includes a selection or other input by a user received by a device via a sensor or other input mechanism of the device. For example, user input includes a selection made via a touchscreen by a user of an option displayed by a graphical user interface generated by the system. User input also includes audio input, such as sound captured by a microphone of a device. User input can also be received via a peripheral for a device, such as a keyboard. User input includes an identified selection by a user of information related to an intelligent reminder, such as a selection of a trigger condition for causing the trigger condition to be associated with the intelligent reminder. In some implementations, user input includes a submission of information by a user for an intelligent reminder. For example, the system may receive input via a touchscreen of a particular geographic location that is to be associated with a criterion for a trigger condition. This may include an address or a selection by a user of an area of a map. User input also includes instructions from a user. For example, the system may receive an instruction to activate an intelligent reminder, or a selection by a user of an option to commence a call to a called party.

The call module 310 identifies a failure to establish a connection for a call that has been commenced. The call module also identifies contact information for a party to the call. This may be the calling party or called party, depending on whether the call is initiated or received by the user for whom an intelligent reminder is provided. The call module can identify contact information, such as a telephone number or username, in call data. The call module is configured to determine whether a connection for the first call has failed to establish with a called party. In some implementations, the system creates an intelligent reminder for reminding a called party to commence a return call after a call initiated by another party has failed to connect with the called party. The call module is configured to determine that the call initiated by the other party has failed to connect with the called party.

The call module 310 can identify that a call has failed to connect based at least in part on call data. In some implementations, the call module 310 determines that a call has failed if call data includes a call status indicative of a failed call. For example, the call module may receive from a calling application a call status of “disconnected,” “cancelled,” or the like, and based on such a status, the call module can determine that the call has failed. In some implementations, call data indicates that a messaging service, such as a voicemail messaging service, has been reached. Similarly, call data may include audio from a call, and the call module may recognize audio of a voicemail greeting. The call module may determine that a call has failed when it determines that a voicemail greeting has been received.

The call module 310 receives user input corresponding to an instruction from a user to establish a call and commences establishing a call. The call module may generate instructions for a calling application to establish a call when an instruction is received from a user to commence a call. The call module may receive from the alert module data associated with commencing a call with a party to be called. For example, the call module may receive an indication from the alert module of a selection of an option to commence a call, including contact information for the party to be called. The call module generates call parameters, which are outputted by the system to an application used for commencing a call. The call parameters include a command to commence a call and contact information for the party to the call. Contact information may include a user name, a contact name, a phone number, or the like. In some implementations, call parameters are formatted for instructing an application used by the user to previously commence a call with the party specified in the alert. For example, the call module may transmit an instruction to a dialer application to commence a call, including contact information for a party to be called. In some implementations, the call module 310 includes an application for commencing and receiving a call. For example, the call module may include a dialer application.

The intelligent reminder creation module 320 creates and maintains intelligent reminders associated with a user, and controls whether an intelligent reminder is active or inactive. Intelligent reminders can be stored in common data formats (e.g., comma separated values (CSV) format) and stored in intelligent reminders data storage 365. Table 900 of FIG. 9 contains representative intelligent reminders. An intelligent reminder is associated with a trigger condition and a party to be called. The intelligent reminder creation module can identify a party to be called for an intelligent reminder in call data associated with a failed call for which an intelligent reminder is being created. Trigger conditions can be identified by the trigger condition module 330.

Intelligent reminders can be created automatically after a failed call without input from a user. However, in some implementations, an intelligent reminder is created after receiving, from a user, an instruction to create an intelligent reminder. For example, the system may receive a selection by a user of an option, displayed during an incoming call, to clear the incoming call and be reminded to return the call later. In some implementations, the intelligent reminder creation module determines whether to create an intelligent reminder based at least in part on a party to the call. For example, the intelligent reminder creation module may automatically create an intelligent reminder for returning a missed call from a called party that has a prior relationship with a user. However, the intelligent reminder creation module may determine to not create an intelligent reminder for returning a missed call from a party that does not have a known prior relationship with the user, such as a known telemarketer.

The intelligent reminder creation module 320 activates an intelligent reminder after it is created. In some implementations, the intelligent reminder creation module activates an intelligent reminder after the trigger condition creation module 330 causes a trigger condition to be associated with the intelligent reminder. In some implementations, the intelligent reminder creation module activates an intelligent reminder after a condition has been met. For example, in some implementations, an intelligent reminder may not be activated until after a pre-determined duration of time has passed from the failure of a call on which the reminder is based. Similarly, the intelligent reminder creation module 320 may activate an intelligent reminder after an event has occurred, such as an alarm clock going off or a meeting concluding, as determined based on a calendar entry for the user.

The intelligent reminder creation module 320 can deactivate an active intelligent reminder. After an intelligent reminder is deactivated, the system does not generate an alert for the intelligent reminder, even when a trigger condition for the intelligent reminder is met. The intelligent reminder creation module may deactivate an intelligent reminder after receiving user input including an instruction to deactivate the intelligent reminder. In some implementations, the intelligent reminder creation module deactivates an active intelligent reminder after determining that a reminder is likely to no longer be desired by a user. For example, the intelligent reminder creation module may deactivate an intelligent reminder if it identifies that after an intelligent reminder has been activated, a user has subsequently participated in a call with a party that the user was going to be reminded to call. Likewise, the intelligent reminder creation module may deactivate an intelligent reminder if it identifies that a device associated with the user has been located within a predetermined physical proximity to a device associated with a party that the system was going to remind the user to call based on the intelligent reminder.

The trigger condition module 330 identifies at least one trigger condition for an intelligent reminder and causes at least one trigger condition to be associated with the intelligent reminder that is created by the intelligent reminder creation module 320. The trigger condition module can identify a trigger condition for an intelligent reminder after the intelligent reminder is created. In some implementations, the trigger condition module identifies a trigger condition for an intelligent reminder, which has not yet been created, after determining that a call commenced by a user has failed or a call has been received by the user but not connected. For example, the system may anticipate that a user may wish to create an intelligent reminder and identify candidate trigger conditions to display to the user for receiving a selection by the user to create an intelligent reminder including the selected trigger condition. In some implementations, identifying a trigger condition includes creating a trigger condition or modifying a stored trigger condition. In some implementations, the trigger condition module identifies multiple candidate trigger conditions, of which at least one is selected for association with an intelligent reminder. In some implementations, the trigger condition module receives input related to a trigger condition from a user and identifies a trigger condition for association with an intelligent reminder based at least in part on the user input. The trigger condition module can automatically identify a trigger condition for an intelligent reminder and cause it to be associated with an intelligent reminder without user input of data for the trigger condition or a selection of a trigger condition by a user. The trigger condition module can cause a trigger condition to be associated with an intelligent reminder by adding the trigger condition to a list of trigger conditions associated with the intelligent reminder. For example, referring again to FIG. 9, if causing a trigger condition to be associated with an intelligent reminder represented in the table 900, the system may add the trigger condition in the trigger conditions column 910 for the intelligent reminder.

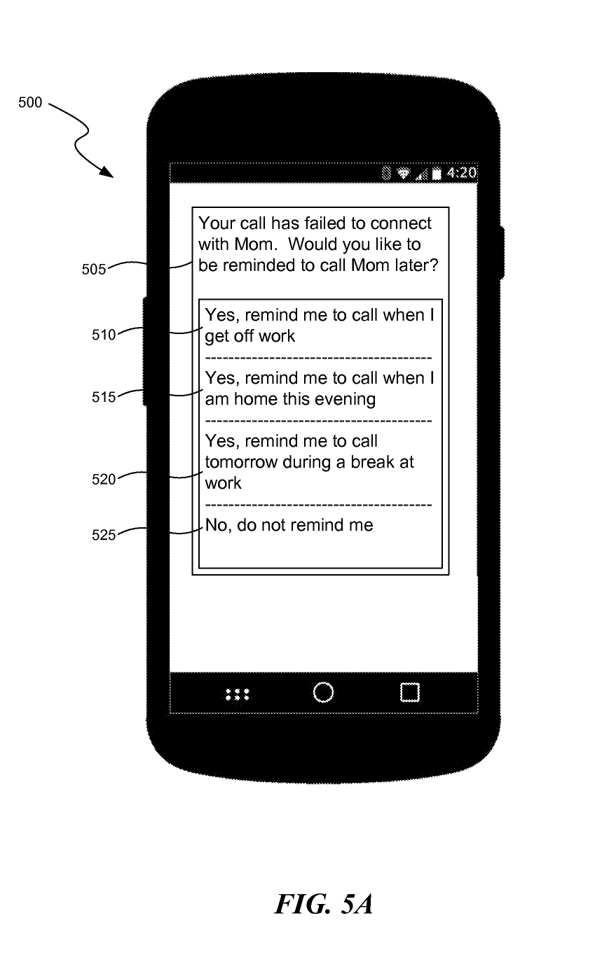

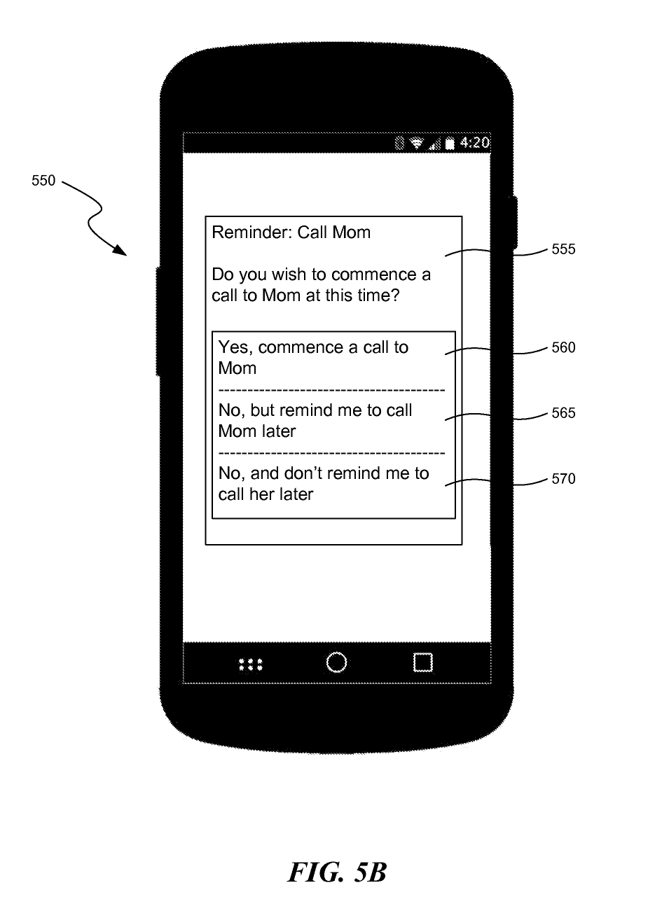

The trigger condition module 330 is configured to identify a trigger condition for an intelligent reminder based on user input. In some implementations, the system includes a wizard software application for receiving from a user information related to an intelligent reminder and/or a trigger condition. For example, the trigger condition module may receive input from a user via a wizard application which describes a property and a value for the property for a criterion of a trigger condition. For example, the user interface module 360 may generate a series of user interfaces for the wizard application for receiving from a user details related to a trigger condition. As a particular example, the system may receive input of a geographic location for a trigger condition, and the trigger condition module may create a trigger condition including a criterion having a geographic location property and a value identified by the user for the geographic location property. A geographic location can be received in various ways, including by detecting a touch via a touch screen on an area corresponding to a location on a displayed map, or by receiving a mailing address from a user. In some implementations, the trigger condition module receives user input of a selection of a candidate trigger condition identified for an intelligent reminder and displayed to the user via a display device, and causes the selected candidate trigger condition to be associated with an intelligent reminder. For example, FIG. 5A shows an interface including candidate trigger conditions, from which the system may receive a selection by a user of a candidate trigger condition that is to be associated with an intelligent reminder.

The trigger condition module can identify a trigger condition stored in trigger conditions data storage 370 for an intelligent reminder. It may also add trigger conditions identified for an intelligent reminder to trigger conditions data storage. Trigger conditions can be stored in various ways. For example, trigger conditions data storage may contain a table including trigger conditions and data associated with those trigger conditions, including criteria for the trigger conditions, including properties for the criteria and respective values associated with the properties. Trigger conditions included in trigger conditions data storage may include template trigger conditions. Template trigger conditions may be created, for example, by a system administrator. In some implementations, a template trigger condition includes for a criterion a property and a default value for the property. The trigger condition module 330 is configured to create new trigger conditions based on data received by the system 300, and to store the created trigger conditions for later use in trigger conditions data storage. In some implementations, the trigger condition module identifies a criterion for a trigger condition including a property and a value associated with the property based on user behavior data received from the user behavior module 350. For example, user behavior data may include that a user commences calls relatively frequently in the evenings while at home, and the trigger condition module can create a trigger condition including criteria that is met when the user is located at home in the evening. Trigger conditions contained in the trigger conditions data storage may include trigger conditions associated with previously established intelligent reminders for a user. For example, candidate trigger conditions may include trigger conditions previously identified by a user for association with intelligent reminders. In some implementations, trigger conditions data storage contains trigger conditions identified as default trigger conditions. In some implementations, a default trigger condition includes a criterion that has been observed to have been met when a user previously connected to a call. In some implementations, the trigger condition module identifies for an intelligent reminder at least one default trigger condition, which it may automatically cause to be associated with an intelligent reminder. The trigger condition module may also receive a selection by a user of a default trigger condition for causing the default trigger condition to be associated with an intelligent reminder.

In some implementations, the trigger condition module 230 identifies for an intelligent reminder a trigger condition that includes a value for a property of a criterion selected based on the value being associated with a high willingness of a user to commence a call. For example, the trigger condition module may identify a value associated with a home location for a geographic location property of a criterion based on a user being more likely to commence calls from home than from other places, as determined based on a call log for the user that associates geographic location with call details. In some implementations, the trigger condition module identifies for a criterion of a trigger condition a value associated with a high willingness of a user to commence a call based at least in part on the user being available to commence a call. For example, the trigger condition module may receive calendar data for a user, identify when during a day a user is not scheduled for a meeting, and identify a trigger condition that will be met when the user is not scheduled for a meeting. In some implementations, the system identifies a value for a property associated with a high willingness of a user to commence a call based on the value for the property being observed when the user connected to an earlier call. In some implementations, a property for a criterion of a trigger condition is associated with a default value associated with a high willingness of the user to commence a call. For example, the system may receive from an administer of the system a predetermined value that is associated with a property, and the system may be instructed to consider the predetermined value as being associated with a high willingness of the user to commence a call. The system may receive data from the user behavior module 350, which it may use to identify a value for a property associated with a high willingness of the user to commence a call. For example, the user behavior module may identify that a user commences calls relatively frequently while driving home from work, and the trigger condition module may identify a trigger condition including criteria that is met when the user is driving home from work.

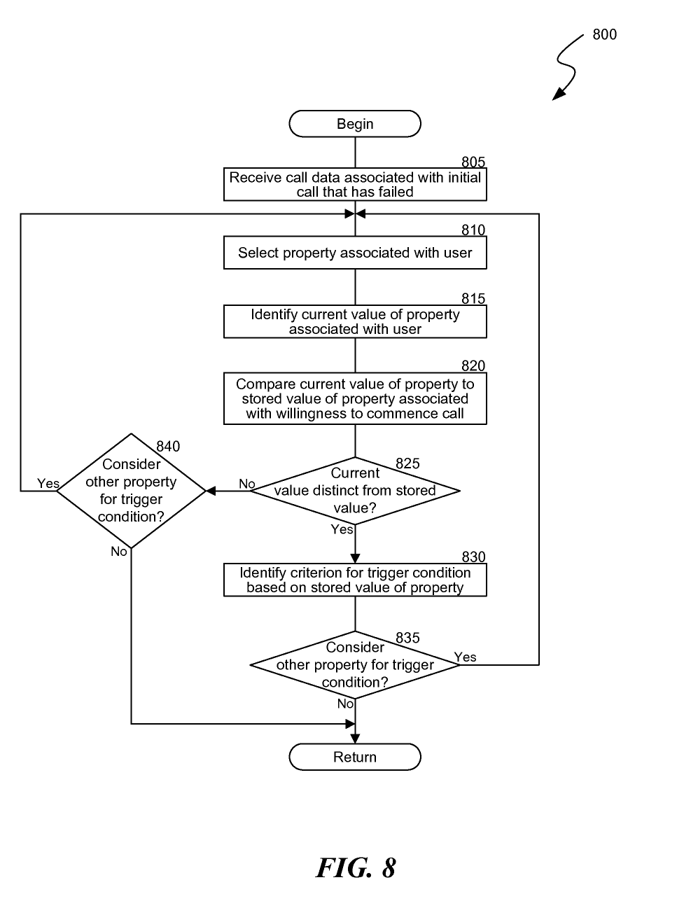

The trigger condition module 330 identifies a trigger condition for an intelligent reminder based at least in part on one or more of environmental data, user data, call data, user input, and user behavior data generated by the user behavior module 350. In some implementations, identifying a trigger condition for an intelligent reminder includes modifying a previously-created intelligent reminder based on the received data. For example, the trigger condition module may change a value associated with a property of a criterion of a trigger condition based on received environmental data. In some implementations, the trigger condition module 330 automatically causes one or more trigger conditions to be associated with an intelligent reminder after it is created. FIG. 8 includes a flow diagram for identifying a trigger condition for an intelligent reminder. In identifying a trigger condition, the trigger condition module may determine whether a stored value for a property is distinct from a current value. More details are discussed below with regard to FIG. 8.

In some implementations, the trigger condition module 330 determines a ranking for candidate trigger conditions and causes a predetermined quantity of highest ranking candidate trigger conditions to be associated with an intelligent reminder. The trigger condition module can identify candidate trigger conditions for an intelligent reminder and rank the candidate trigger conditions based on a calculated trigger condition score. In some implementations, the trigger condition module calculates a trigger condition score for each identified candidate trigger condition, and it causes trigger conditions having a score greater than a threshold to be associated with the an intelligent reminder.

A trigger condition score may reflect a determined likelihood that conditions meeting a trigger condition will be encountered by a mobile device at an opportune occasion for the user of the device to commence a call to a party associated with the intelligent reminder. For example, a trigger condition score may be between 0 and 1, with a score of 1 associated with a high likelihood that the trigger condition will be encountered at an occasion that a user would find opportune for a call, and a score of 0 associated with a low such likelihood. In some implementations, the trigger condition module 330 calculates a trigger condition score based at least in part on a likelihood that a trigger condition will occur. The trigger condition module may identify a likelihood that a trigger condition will occur based at least in part on comparing the trigger condition to historical data gathered by the user behavior module 350. Historical data may include geographic information for a mobile device, a work schedule for a user, a sleep schedule for a user, and so forth. For example, if environmental data includes current GPS coordinates for a mobile device determined to be within a predetermined proximity of a known work location for a user, and the user behavior module identifies that the user leaves work on 99% of work days, the trigger condition module may determine that there is a likelihood of 0.99 that the user will leave work. A trigger condition score can also be calculated based at least in part on a determined likelihood that the trigger condition will be met at an occasion that a user historically participates in a call. For example, the user behavior module 350 may identify that a user participates in calls 30% of days that the user commutes from home to work. The trigger condition module may identify a candidate trigger condition including that the user be commuting, and determine that a likelihood of the trigger condition occurring when the user historically participates in a call is 0.3. The trigger condition module can generate a trigger condition score by combining determined likelihoods for a trigger condition and scaling the score. For example, the trigger condition module may calculate a trigger condition score by adding a likelihood that a trigger condition will occur and a likelihood that a user participates in a call under the trigger condition and divide by two.

The alert module 340 monitors for a trigger condition associated with an active intelligent reminder and generates an alert that is outputted by the system when the trigger condition is met. The alert can include audible and visual elements, and the system can instruct a user's mobile device to display a GUI including visual elements of the alert generated by the user interface module 360. The alert includes an option to commence a call with a party associated with the intelligent reminder. The alert module is configured to receive user input of a selection to commence a call with the party associated with the intelligent reminder and output data to the call module 310 for commencing a call with the party to be called.

The alert module 340 determines whether a trigger condition is met by comparing environmental data, user data, call data, and user input to the trigger condition. Comparing this data to a trigger condition may include comparing received data to values of properties included in criteria of active trigger conditions. In some implementations, a trigger condition includes a criterion including a property and a value or range of values for the property, and the alert module 340 generates an alert when it identifies in environmental data, user data, and/or user input the value or range of values for the property. For example, a property of a trigger condition may include a geographic location of a mobile device, and a value for the property may include a latitude and longitude for a home location of a user, as determined by the user behavior module. The alert module 340 may generate an alert when it identifies environmental data for the mobile device including geographic coordinates of the device within a predetermined distance from the latitude and longitude for the home location of the user. In some implementations, the alert module generates an alert when environmental data, user data, and/or user input meet a threshold value for a property of a trigger condition. For example, a property and associated threshold values for criteria of a trigger condition may be that it be a time 30 minutes removed from a conclusion of a scheduled event and a user be geographically situated at a predetermined distance away from a location of the event. The alert module may generate an alert when both the threshold time and geographic distance are observed in environmental data, thus meeting the criteria of the trigger condition. In some implementations, a criterion for a trigger condition may include a range of values associated with a property and a value within the range of values must be maintained for a predetermined period of time, and the alert module generates an alert when the property maintains the value for the period of time. For example, a trigger condition may include that a mobile device be in an active state (e.g., a user interacting with the mobile device) for a duration of time equal to or greater than five minutes, and the alert module may generate an alert when it observes that the mobile device is in an active state for five minutes. In some implementations, the alert module determines to not generate an alert for an intelligent reminder even though a trigger condition has been met. For example, the alert module may identify that a mobile device is in motion and wait until after the mobile device has stopped moving to generate an alert. Similarly, the alert module may determine that a user is driving and generate an alert after the alert module determines that the user is no longer driving.

The user behavior module 350 receives environmental data, user data, call data, and user input, and identifies behaviors of the user, including trends in a user's mobile device activities, physical locations visited by a user, a user's preferences in activities, a user's preferences for intelligent reminders (e.g., trigger conditions that result in a call commenced by the user) and the like. The user behavior module also calculates likelihood scores for identified behaviors. A likelihood score can represent a historical percentage of occurrences for an identified behavior by the user. The likelihood score can be calculated for a time period, a particular time, a location, an activity, or the like. In some implementations, it is represented on a scale from 0 to 1, with 1 being a behavior with a highest likelihood (e.g., 100% occurrence rate). For example, for an observed behavior of a user leaving work at 6:00 p.m., occurring three days of every five days of the work week, a likelihood score may be calculated to be 0.6.

The user behavior module 350 identifies various behaviors of the user. The user behavior module identifies behaviors related to geographic location information. For example, the user behavior module can identify that a user has a high likelihood of being home between identified times in a day, at work at other times of the day, and at school in between. In some implementations, the user behavior module cross references location information with a map and/or location database to identify information associated with the location information, such as whether it is associated with a house, a restaurant, a school, or a business. In some implementations, the user behavior module receives specific location information, such as an address, that is significant for a user. For example, the user behavior module may identify a mailing address for a user in an address book. In some implementations, the system identifies significant locations for a user based on observed user behavior. For example, the user behavior module may identify a home location for a user if it observes that a user is located in a residential location a majority of nights of a week.

The user behavior module 350 also identifies calling behavior for a user. Calling behavior includes time periods of a day that a user typically participates in calls, a nature of a call during a particular time of a day (e.g., a work call, a personal call), call information at particular locations or during activities, and the like. For example, the user behavior module may identify that a user commences a majority of calls to personal contacts during a particular time period each day, or on particular days, and a majority of calls to business contacts other times of the day. Similarly, the user behavior module may identify mobile device usage trends. For example, the user behavior module can identify a likelihood that a device will be active during a time period based on historical user interaction with a device. The user behavior module can also identify for a property of a criterion of an intelligent reminder a value associated with a high willingness of the user to commence a call. For example, the user behavior module may monitor values of a property when a user commences calls and determine that the values are associated with a high willingness of a user to commence a call.

Any of the intelligent reminder creation module 320, the trigger condition module 330, and the alert module 340 can use identified behaviors and likelihood scores. For example, the trigger condition module 330 can use identified behaviors and likelihood scores for identifying trigger conditions and/or calculating trigger condition scores. The trigger condition module may also use behavior data for identifying a value of a property associated with a high willingness of the user to commence a call. The intelligent reminder creation module 320 can use identified behaviors and likelihood scores for determining whether to create an intelligent reminder or deactivate an active intelligent reminder. The alert module 340 can use identified behaviors and likelihood scores for determining whether to generate an alert associated with an active intelligent reminder. The user behavior module may store identified trends, behavior, and historical mobile device storage 280.

The user interface module 360 generates various user interfaces, including interfaces for displaying information to a user and interfaces for receiving information or other input from the user. The user interface module generates a GUI for an alert generated by the alert module 340, and it may receive via the GUI input from the user, including a selection of an option to commence a call to a party. The user interface module also generates interfaces for displaying trigger conditions to a user and receiving a selection by a user of a trigger condition. The user interface module also is configured to generate an interface for receiving an incoming call. For example, the user interface module may receive call data from an application used for connecting a call, and the user interface module may generate an interface for receiving a selection by a user of displayed options for connecting the call, ignoring the call, and ignoring the call and creating an intelligent reminder. In some implementations, the user interface module generates a component of an interface, which another application can incorporate into an interface it generates. For example, an interface for an incoming call generated by a dialer application may include an option for creating an intelligent reminder, generated by the user interface module. The user interface module 360 generates other interfaces for displaying information to a user and for receiving input from a user, as discussed herein.

### Example Processes

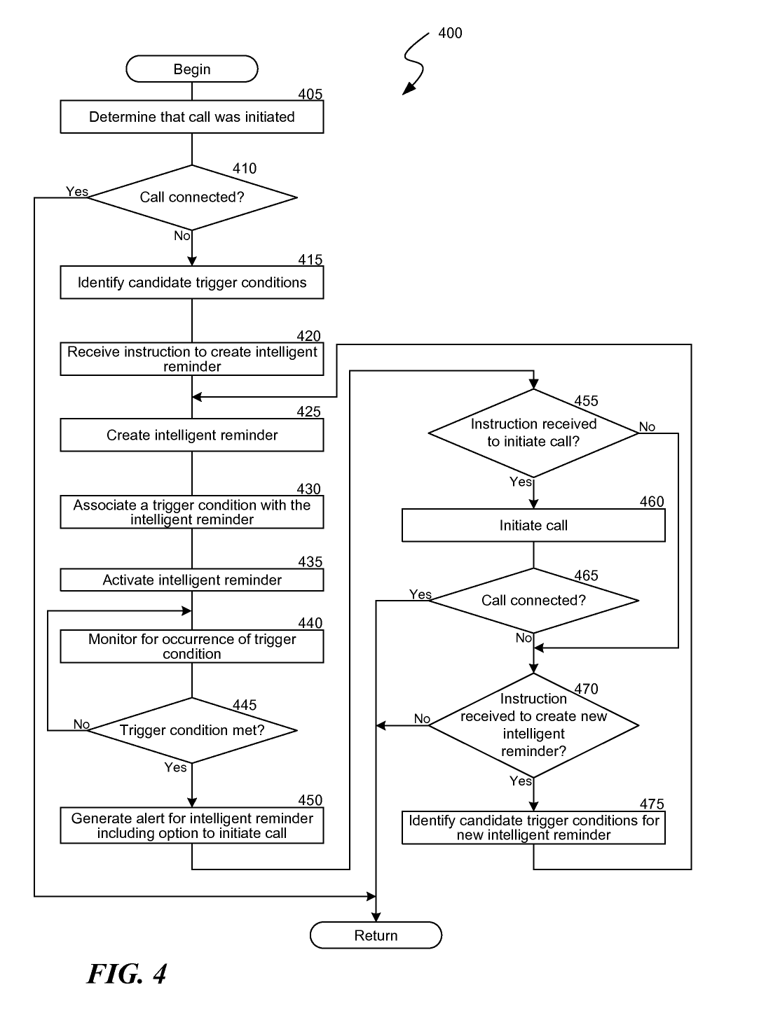

The system 300 can provide an intelligent reminder by a mobile device. FIG. 4 is a flow diagram of a process 400 performed by the system 300 for providing an intelligent reminder on a mobile device after a user of the mobile device has commenced a call to a called party but the call has failed to connect with the called party. At a block 405, the system determines that a call for connecting to the called party was initiated by the mobile device. The call can be commenced via a dialer application for placing voice calls over a cellular network, an application for voice over IP communications, or a similar application. In some implementations, the call is a video call, or a call for another type of live communications session. The system can detect that the call was initiated after the mobile device receives a selection by a user of an option to commence a call with the called party and the application used for calling has commenced attempting to connect with the called party. For example, the system may receive from the application used for placing the call an indication that it is transmitting data to a service provider for attempting to connect a call with the called party.

At a decision block 410, the system 300 determines whether the call initiated by the mobile device has connected with the called party. The system can determine whether a call has connected or failed to connect based on a status of the call. In some implementations, call data identifies a call status. For example, call data may include that the called party has connected to the call, that the call is pending but not connected, that a voicemail system has been connected to, that the call has been abandoned by a user of the mobile device or the called party, or the like. The system may receive call data from an application used for commencing a call. In some implementations, the system infers a call status based on call data, including whether a connection has been established, or whether a connection has failed or is still pending, or the like. If the system 300 determines that the call has connected with the called party, the process 400 returns. If the system determines that the call has failed to connect with the called party, the process proceeds to a block 415. In some implementations, the system determines that a call has not connected if it has not received an indication that the call has connected. The system may determine that a call has not connected if call data indicates that a call is pending or has failed. In some implementations, if the system determines that the call has not connected but also has not failed (e.g., the call is pending) the system 300 takes no action until it determines that the call has failed or connected. However, if the system determines that a call has been pending for a time period greater than a threshold value, the system may determine that the call has failed.

At a block 415, the system 300 identifies candidate trigger conditions. The system can identify candidate trigger conditions from among trigger conditions stored in trigger conditions data storage. A stored trigger condition includes at least one criterion that is to be met for the trigger condition to be met. In some implementations, a value associated with a property of a criterion is selected or modified based at least in part on user input; environmental data, including environmental data when the intelligent reminder is created; user data; or call data. For example, the system may identify in calendar data associated with a user a scheduled meeting, and the system may identify a candidate trigger condition that is met when a meeting concludes. The system can assign a value, such as a geographic location, for a criterion of the candidate trigger condition, which will be observed by the system when the meeting concludes. The value, such as the geographic location, can be identified based on environmental data. In some implementations, the system identifies a candidate trigger condition based at least in part on a value for a property of the trigger condition being different from a value for the property currently being observed by the system. For example, the system may identify a trigger condition that includes a value for a geographic location property that is different, by a predetermined amount, from a current geographic location of a mobile device.

In some implementations, the system identifies a candidate trigger condition based at least in part on historical user behavior. For example, the system may identify historical user behavior including that a user frequently commences calls while driving home from work, and the system may identify a candidate trigger condition that is met when the user is driving home from work. In some implementations, the system identifies a candidate trigger condition in trigger conditions previously used for intelligent reminders for a user. For example, the system may identify a trigger condition most frequently used for intelligent reminders for a user. In some implementations, the system identifies a candidate trigger condition among default trigger conditions. For example, the system may include default, pre-determined trigger conditions. Additional details related to identifying candidate trigger conditions are discussed throughout, including with respect to FIG. 8.

At a block 420, the system 300 receives from a user an instruction to create an intelligent reminder. The system may receive the instruction via an interface for creating an intelligent reminder. For example, the system may generate an interface including both a message indicating that a call has failed and an option to create an intelligent reminder. The option to create an intelligent reminder can include various candidate trigger conditions identified by the system that can be selected by a user. The system may receive a selection of a trigger condition, which it interprets as an instruction from the user to create an intelligent reminder. FIG. 5A shows an interface 500 displayed by a mobile device for receiving a selection by a user of an option to create an intelligent reminder. The interface includes a message 505 indicating that a call has failed. The interface also includes multiple options for creating an intelligent reminder. A first option 510 identifies a first candidate trigger condition, which includes that the user be off work. A second option 515 identifies a second candidate trigger condition, which includes that the user be home in the evening. A third option 520 identifies a third candidate trigger condition, which includes that the user be on a break at work on the following day. The interface also includes an option 525 that a user can select to not create an intelligent reminder. The system may interpret a selection of the first option 510, the second option 515, or the third option 520 as an instruction to create an intelligent reminder.

At a block 425, the system 300 creates an intelligent reminder. The intelligent reminder includes a reminder to call the called party who was the called party of the call that failed. At a block 430, the system associates a trigger condition with the intelligent reminder. As discussed above, the system may receive a selection by a user of a candidate trigger condition via an interface generated by the system. For example, referring again to FIG. 5A, the system may receive a selection by a user of the first option 510 identifying a trigger condition for reminding the user to commence a call when the user is off work. In some implementations, the system receives a custom trigger condition from a user. For example, the system may generate an interface for receiving from a user a custom trigger condition, including at least one criterion and a property and value associated with the criterion. A custom trigger condition can identify a geographic location, a time or time range, a place (e.g., home, grocery store, etc.), an event (e.g., an end of a sporting event or movie), or the like.

In some implementations, the system 300 automatically associates a trigger condition with the intelligent reminder that is created. For example, the system can automatically associate a trigger condition with an intelligent reminder after receiving, via an interface generated by the system, a selection by a user of an option to create the intelligent reminder. As discussed above, the system can identify candidate trigger conditions. The system may score and rank candidate trigger conditions and automatically associated at least one of the highest ranking candidate trigger conditions with an intelligent reminder. FIG. 8 shows a flow chart of a process for identifying candidate trigger conditions for an intelligent reminder. In some implementations, the system associates multiple trigger conditions with an intelligent reminder.

At a block 435, the system activates the intelligent reminder. The system can activate the intelligent reminder after a trigger condition has been associated with the intelligent reminder. This can be done automatically. In some implementations, however, the system activates an intelligent reminder upon receiving a user's confirmation to do so. In some implementations, the system activates the intelligent reminder after a predetermined hibernation period, or after a predetermined event has occurred.

At a block 440, the system monitors for an occurrence of a trigger condition associated with the active intelligent reminder. The system monitors for an occurrence of a trigger condition by comparing the trigger condition to data received, measured, or otherwise possessed by the mobile device. For each criterion of a trigger condition, the system determines whether the criterion is met based at least in part on whether an observed value for a property of the criterion is within a range of acceptable values for the property, as required by the trigger condition. In some implementations, a trigger condition requires that an observed value be equivalent to a stored value. A trigger condition can also list multiple acceptable values for meeting the criterion, or a range of values. In some implementations, a trigger condition includes various criterions, and the system monitors for an occurrence of each of the criterions.

The system 300 monitors values for properties associated with a trigger condition by observing, among other types of data, environmental data, such as geographic location information for the mobile device; a time; user data, including a calendar for a calling and/or called party and text of messages sent or received by the mobile device (e.g., SMS messages, e-mail messages); a WiFi network detected or connected to by the mobile device; a device detected by the mobile device via Bluetooth® or another short-range wireless protocol; motion information, including whether a device is moving or stationary; and a state of the phone (e.g., active mode, sleep mode). For example, if a trigger condition for an intelligent reminder includes that a mobile device be at a geographic location associated with a home of a user, the system may compare GPS coordinates determined by the mobile device to GPS coordinates for a home of the user.

At a decision block 445, the system determines whether a trigger condition associated with the intelligent reminder has been met. The system determines that a trigger condition is met when it observes conditions that meet criteria of the trigger condition. Tor a trigger condition including one criterion, the system may determine that the trigger condition is met when it observes a predetermined value for a property of the criterion. For example, if a criterion of a trigger condition includes a property corresponding to geographic location of a mobile device and a value for the property of “home,” the system may determine that the trigger condition is met when it observes geographic coordinates for the mobile device within a range of coordinates associated with the location, “home.” In some implementations, a trigger condition is associated with multiple criterions that must be met for the system to determine that the trigger condition is met. For example, if a trigger condition for an intelligent reminder includes criteria that a user be identified commuting from home to work, the system may determine that the trigger condition is met when environmental data includes values meeting the criteria, such as a location of a user device being not equal to a work location for the user and the movement of the user device being toward a home location. In some implementations, multiple trigger conditions are associated with an intelligent reminder, but fewer than all of the trigger conditions must be met for the system to generate an alert for the intelligent reminder. In some implementations, an intelligent reminder is associated with two or more trigger conditions and at least two trigger conditions must be met for the system to generate an alert for the intelligent reminder. If at decision block 445, the system 300 determines that the trigger condition has not been met, the process returns to a block 440, and the system continues monitoring for an occurrence of the trigger condition. If the system determines that the trigger condition has been met, the process proceeds to a block 450.

At a block 450, the system generates an alert associated with the intelligent reminder, which includes an option to commence a call with the called party. The alert may include audible and tactile elements in addition to visual elements. For example, for an alert on a mobile device, the system may generate an interface including an option to call the called party and cause the mobile device to play a ringtone. FIG. 5B shows a representative interface 550 for an alert generated by the system. The interface includes a reminder 555, which includes text that explains to the user to the purpose of the alert. The interface includes various options that may be selected by the user. A first option 560 includes commencing a call to a called party associated with the intelligent reminder: Mom. A second option 565 includes to not commence a call to the called party, but to remind the user later to commence a call to the called party. A third option 570 includes to not commence a call to the called party, and to not remind the user to commence a call later. The system may receive a selection by the user of one of the three options.

At a decision block 455, the system determines whether an instruction has been received to initiate a call with the called party. The instruction may comprise a selection of an option to initiate a call with the called party, received via an interface generated by the system as part of the alert and displayed on a display of the mobile device. For example, via the interface 550 shown in FIG. 5, the system could receive a selection of the option 560 to commence a call with contact, “Mom.” If a selection to commence a call to the called party is not received, the process proceeds to a decision block 470. In some implementations, the system receives a selection of an option to not commence a call. For example, the system may receive an instruction from a user to dismiss the intelligent reminder. Referring to FIG. 5B, for example, the system may receive a selection of either of the options 565 or 570 for not commencing a call to the called party. In some implementations, the system receives an indication of a selection of a “snooze” for the intelligent reminder. The system may also receive a selection to clear an alert.

If at decision block 455, the system 300 receives an instruction to initiate a call, the process proceeds to a block 460. At block 460, the system transmits, to an application used for connecting calls, an instruction to commence a call with the called party. The instruction includes an identifier for the called party. For example, the system may transmit to a dialer application an instruction to commence a call with the called party, identifying the called party by a username. In some implementations, the system generates the instruction for the application used for the call that was determined to have failed at block 410.

At a decision block 465, the system 300 determines whether the call initiated by the system has been connected. The system may determine whether the call has been connected as described with respect to block 410. If the system determines that the call was connected, the process returns. If the system determines that the call was not connected, the process proceeds to decision block 470.

At decision block 470, the system 300 determines whether an instruction has been received to create a new intelligent reminder. In some implementations, the system automatically sets a new intelligent reminder if the call is not connected. In some implementations, the system receives an instruction from a user to create a new intelligent reminder. For example, referring again to FIG. 5B, a selection may be received of the option 565 to be reminded to call contact, “Mom,” later. Similarly, the system may receive a selection of an option to “snooze” the intelligent reminder. If the system does not receive an instruction to create a new intelligent reminder, the process 400 returns. If the system receives an instruction to create a new intelligent reminder, the process proceeds to a block 475.

At block 475, the system 300 identifies candidate trigger conditions for the new intelligent reminder. The system may identify candidate trigger conditions for the new intelligent reminder in a similar manner as described with respect to block 415 using current data identified by the system. In some implementations, the system identifies candidate trigger conditions based on environmental data, user data, behavior data, user input, and/or call data, as received or identified at a time that the second call fails. The system can also consider environmental data, call data, and the like, and candidate trigger conditions from when the previous intelligent reminder that was set. For example, the system can select candidate trigger conditions that were not used for the earlier intelligent reminder. In some implementations, if a user has selected to “snooze” a first intelligent reminder, the system removes a trigger condition that has been triggered from a list of trigger conditions associated with the first intelligent reminder. The system may cause another trigger condition to be associated with the intelligent reminder, or, if multiple trigger conditions were already associated with the first intelligent reminder, the system may merely remove the trigger condition from the first intelligent reminder and leave the intelligent reminder active.

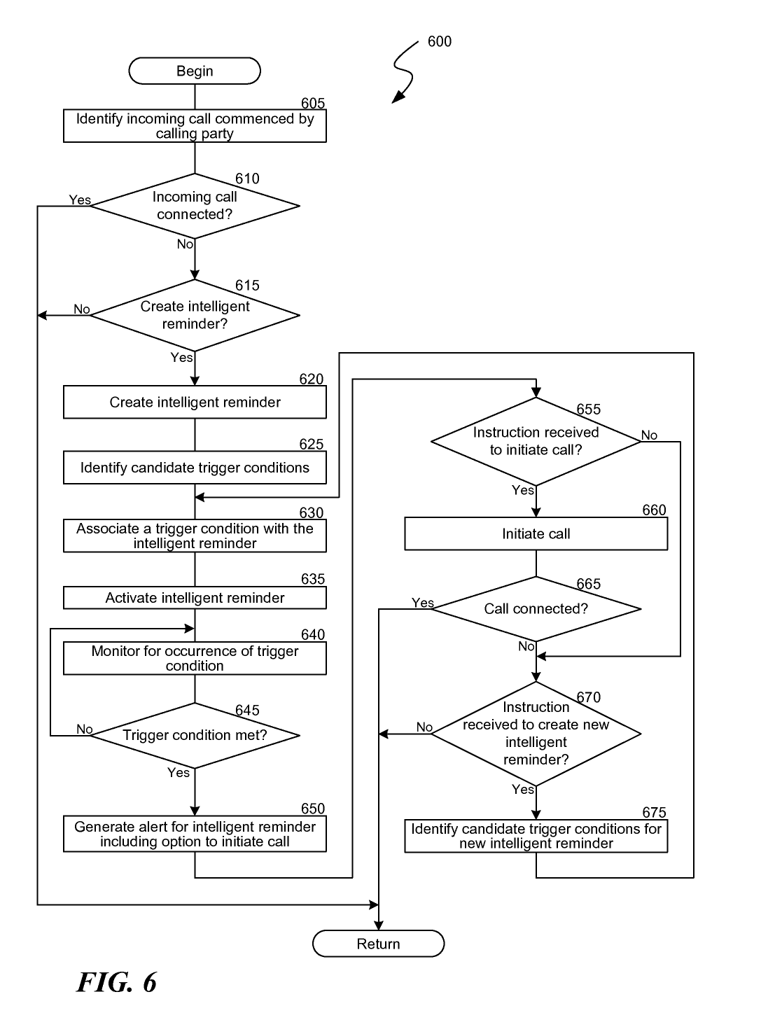

The system 300 can provide an intelligent reminder on a mobile device after an incoming call fails to connect with a user. The system generates an alert when the intelligent reminder is triggered and provides an interface for quickly commencing a return call to the calling party of the failed incoming call. FIG. 6 is a flow diagram of a process 600 performed by the system 300 for providing an intelligent reminder on a device. At a block 605, the system 300 identifies an incoming call commenced by a calling party. The system identifies an incoming call in call data received from an application for connecting incoming calls. The call data identifies the calling party. It may include a name of the calling party, a phone number, or the like.

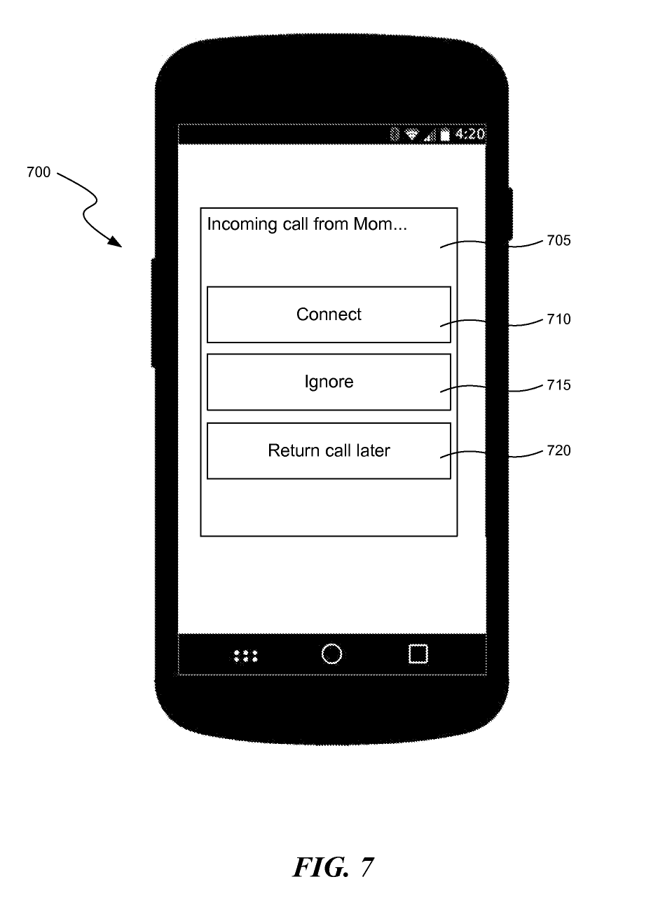

At a decision block 610, the system 300 determines whether the incoming call has been connected. In some implementations, the system determines that a call has been connected when it receives user input of a selection of an option to connect the call. FIG. 7 shows a representative interface 700 generated by the system for receiving an incoming call. The interface includes a notification 705 of the incoming call and a connect option 710, an ignore option 715, and a return call later option 720. The system may receive a selection of the connect option 710, and, as a result, determine that the call has been connected. In some implementations, the system determines whether a call has been connected based on call data from an application used for receiving and connecting the call. Call data may identify a status of a call, including whether the call has been connected. If the system determines that the call has been connected, the process 600 returns. If the system determines that the call has not been connected with the user, the process 600 proceeds to a decision block 615. In some implementations, the system determines that a call has not been connected based on user input. For example, referring again to the interface 700 of FIG. 7, the system may receive a selection of either the ignore option 715 or the return call later option 720, and therefore determine that the call has not been connected. The system may also determine that a call has not been connected based on call data, including a call status. Call data may also specify that a call has been cancelled by a calling party, or otherwise disconnected. In some implementations, the system determines that an incoming call is not connected if it does not identify that the call is connected within a predetermined time period from when the incoming call was first identified.

At decision block 615, the system 300 determines whether to create an intelligent reminder for commencing a return call to the calling party. In some implementations, the system determines whether to create an intelligent reminder based on user input received in reference to an incoming call. For example, the system may generate an interface for display by a mobile device while an incoming call is pending and ringing, and the interface may include various options associated with handling the call and creating an intelligent reminder. One option may be to not connect the call and not create an intelligent reminder, and another option may be to not connect the call and to create an intelligent reminder for a return call. For example, referring again to FIG. 7, the ignore option 715 may be associated with not connecting the incoming call and not creating an intelligent reminder, and the return call later option 720 may be associated with not connecting the incoming call but creating an intelligent reminder. The system can determine whether to create an intelligent reminder based on a selection by the user of one of the options.

In some implementations, the system automatically creates an intelligent reminder after an incoming call is identified to have not been connected. For example, the system may have determined that a user has missed an incoming call based on identifying that a predetermined time period has elapsed since identifying the incoming call and no input from the user has been received in reference to the incoming call. Based on determining that the user missed the call, the system may automatically create an intelligent reminder. If the system determines to not create an intelligent reminder, the process 700 returns. If the system determines to create an intelligent reminder, at a block 620, the system creates an intelligent reminder. For example, the system may maintain a table including intelligent reminders, and the system may create an intelligent reminder by adding an entry including contact information for the calling party to the table.

At block 625, the system identifies candidate trigger conditions for the intelligent reminder. The system can identify a candidate trigger condition in the ways for identifying candidate trigger conditions discussed herein, including above with reference to block 415 of the process 400 of FIG. 4 and below with reference to FIG. 8. In some implementations, the system identifies a candidate trigger condition based at least in part on user input received via an interface associated with an incoming call. For example, if the system receives a selection by a user of an option associated with creating an intelligent reminder, it may identify a candidate trigger condition based on a high likelihood, determined by the system, that the trigger condition will be triggered after the user has completed a current activity and not before the current activity is complete. In some implementations, the system identifies a candidate trigger condition based at least in part on not receiving user input during an incoming call. For example, after determining that a call failed because no selection by a user was received to connect the incoming call, the system may identify a trigger condition that is unlikely to occur until after a device moves from its current location. For example, the system may identify that the device is in a pocket of a user, based on data received from an image sensor and a proximity sensor, and the system may identify a trigger condition that is unlikely to occur until the device has been removed from the pocket.

At a block 630, the system 300 causes a trigger condition to be associated with the intelligent reminder. The system can cause a trigger condition to be associated with the intelligent reminder in the ways discussed above with respect to block 430 of FIG. 4, and in the ways discussed below with reference to FIG. 8. Blocks 635-675 are largely analogous to respectively similar blocks 435-475 of the process 400 of FIG. 4. Indeed, at a block 635, the system activates the intelligent reminder. The system may activate the intelligent reminder as discussed above with respect to block 435. At a block 640, the system monitors for an occurrence of a trigger condition associated with the intelligent reminder. The system may monitor for an occurrence of a trigger condition as discussed above with respect to block 440. At a block 645, the system determines whether a trigger condition has been met. If the system determines that no trigger condition has been met, the process returns to block 640. If the system determines that the trigger condition has been met, the process proceeds to a block 650. The system may determine whether a trigger condition has been met as discussed above with respect to block 445. At block 650, the system generates an alert for the intelligent reminder. The alert includes an option to initiate a call to the calling party of the incoming call identified with respect to block 605. As discussed above, the alert can include audio, visual, haptic, or other elements. For example, the system may generate an interface similar to the interface 550 of FIG. 5B. The system may generate an alert as discussed above with respect to block 450.

At a decision block 655, the system 300 determines whether an instruction has been received to initiate a call to the calling party. If no instruction is received to initiate a call to the calling party, the process proceeds to a decision block 670. If an instruction is received to initiate a call to the calling party, the process proceeds to a block 660. At block 660, the system initiates a call to the calling party. For example, the system may cause an application that received the incoming call identified at block 605 to commence a call to the calling party. The system may initiate a call to the calling party as discussed above with respect to block 460. At a decision block 665, the system determines whether the call was connected. If the system determines that the call was connected, the process 600 returns. If the system determines that the call was not connected, the process proceeds to decision block 670. At decision block 670, the system determines whether an instruction has been received to create a new intelligent reminder. If no instruction has been received to create a new intelligent reminder, the process 600 returns. If an instruction has been received to create a new intelligent reminder, the process proceeds to a block 675. In some implementations, the system automatically creates a new intelligent reminder. At block 675, the system identifies candidate trigger conditions for the new intelligent reminder. The system may identify candidate trigger conditions for the new intelligent reminder as described above with respect to block 625. The system may consider call data associated with the call initiated at block 660 in identifying trigger conditions for the new intelligent reminder. In some implementations, the new intelligent reminder includes the previous intelligent reminder with different trigger conditions. The system may identify candidate trigger conditions in the ways discussed above with respect to block 675. The process 600 proceeds back to block 630, and the system causes a trigger condition to be associated with the new intelligent reminder.

The process 600 is described with reference to the mobile device generating the alert and commencing the call initiated via the alert. However, in some implementations, another device may generate the alert and/or commence the call to the calling party. For example, the system may determine that a personal computer is in a vicinity of the user and being used by the user, and the system may cause the personal computer to generate an alert when a trigger condition is met. The system may enable a user to commence a call via the alert generated by the personal computer.

FIG. 8 is a flow diagram depicting a method 800 performed by the system 300 for identifying candidate trigger conditions for an intelligent reminder. In some implementations, the system automatically causes an identified candidate trigger condition to be associated with an intelligent reminder. In some implementations, the system receives a selection by a user of a candidate trigger condition for associating the selected trigger condition with an intelligent reminder. The system may perform the method 800 in association with either of the methods 400 and 600 of FIGS. 4 and 6, respectively. For example, the system may perform the method 800 as part of blocks 415-435 of FIG. 4. At a block 805, the system 300 receives call data associated with an initial call that has failed to connect with a user. The call may have been commenced by the user or another party. The call data identifies a party to the call—the called party or the calling party, depending on whether the call that failed to connect with the user was a call commenced by the user or by the party to the call.

At a block 810, the system 300 selects a property associated with the user. The system can identify a candidate trigger condition based on a value of the property associated with a high willingness of the user to commence a call. For example, a property associated with the user may be a geographic location of the user, which can be determined based on a measured geographic location of a mobile device held by the user. A value of this property associated with a high willingness of the user to commence a call may be a home location associated with the user. Thus, a trigger condition may be identified based on the home location associated with the user.

The system can select a property from among various properties associated with the user. Properties associated with the user include a geographic location, a place, an event attended by the user, a schedule of the user, a status of the user (e.g., available or busy, according to a calendar application), a status of a mobile device of the user (e.g., whether it is in use, an application being used), a status of a user's vehicle, a velocity of the user, a direction of a user, a network sensed or connected to by the user device, devices in a vicinity of the user's mobile device, and similar properties. In some implementations, the system selects a property from a list of properties maintained by the system. For example, the trigger condition module 230 may maintain a list of properties in trigger conditions data storage. Each property from the list may be associated with at least one value associated with a high willingness of the user to commence a call. In some implementations, a property includes multiple sub-properties and multiple values associated with those sub-properties. For example, a property may include a geographic coordinate and a time of day, and a value associated with the property associated with a high willingness of the user to commence a call may include geographic coordinates of a home location and a time range that includes evening hours. Similarly, the system may consider multiple properties at once.

At a block 815, the system 300 identifies a current value of the selected property associated with the user. The current value of the selected property may be identified at a time that an intelligent reminder is created or that a call fails to connect with the user. A current value may include a number, a measurement, a quantity, a state, a status, or the like, depending on the property associated with the user. For example, a value associated with a geographic location may include a name of a place or geographic coordinates. A state of a device may include, for example, “in use” or “idle.” A status of a user according to a calendar application may include busy and available. A motion of a user may include a velocity or an activity identified by a mobile device (e.g., riding in a train). A status of an event may include that the event is ongoing or completed. An event may include, for example, a sporting event. A status of a user's vehicle may include that it is in motion, idling, or off. A value of a property associated with mobile devices in a vicinity of the user may include a username associated with a user of a device sensed by a mobile device of the system.

The system identifies a current value for a property in various ways. In some implementations, the current value is identified in environmental data received by the system. For example, the system may receive a service set identifier (SSID) for a wireless network from a wireless router, received via a WiFi adapter of a device. A current value of the property can also be found in user data, user input, and call data. In some implementations, the system receives a current value for a property from an application operating on a mobile device of the user. For example, the system may receive information related to scheduled events from a calendar application operating on the mobile device. In some implementations, the system identifies a current value of a property by processing received data. For example, the system may receive velocity information for a user from an application for tracking geographic location information for a device based on GPS data, and the system may determine, based on the velocity, a current value for a property associated with the user's current activity, such as whether the user is riding a bus or riding a train. The system 300 may store the current value of the property associated with the user in the user data storage area 375.

At a block 820, the system 300 compares the identified current value of the property with a stored value of the property associated with a high willingness of the user to commence a call. As discussed above, the system 300 maintains a list of properties associated with a user and values for the properties associated with a high willingness of the user to commence a call. A value may be identified by the system by observing user behavior. A value may also be received by the system from an administrator of the system, or received from the user. For example, the system may receive from a user a value associated with a high willingness of the user to commence a call.

At a decision block 825, the system 300 determines, based on the comparison, whether the current value is distinct from the stored value. In some implementations, the system determines that a current value is distinct from a stored value when the stored and current values are different. For example, a current value for a sensed WiFi network may be a first network, and a stored value for a sensed WiFi network may include multiple network names, none of which are the current value. Therefore, the system may determine that the current value is distinct from the stored value. In some implementations, the system determines that a current value is distinct from a stored value when the current value is not within a predetermined difference from the stored value. For example, a stored value may include geographic coordinates, and the system may determine that a current value is not distinct from the stored value when the current value is within a predetermined distance from the stored geographic coordinates. If the system determines that the current value is not distinct from the stored value, the process proceeds to a decision block 840.

At a decision block 840, the system determines whether to consider another property for identifying a trigger condition for the user. In some implementations, the system does consider another property for identifying a trigger condition when there exists another property in a list of properties maintained by the system, and the other property has not been considered by the system for identifying a trigger condition. In some implementations, the system considers all properties associated with criteria for a trigger condition. If the system determines to not consider another property for identifying a trigger condition for the user, the process 800 returns. If the system does determine to consider another property for identifying a trigger condition for the user, the process returns to block 810, and the system 300 selects a property associated with the user.

If at decision block 825, the system 300 determines that the current value is distinct from the stored value, the process 800 proceeds to a block 830. At block 830, the system identifies a criterion for a trigger condition based at least in part on a stored value of the property associated with a high willingness of the user to commence a call. In some implementations, the identified criterion includes that a stored value of the property associated with a high willingness to commence a call is observed. In some implementations, the identified criterion includes that any of a range of values be observed, and the range of values is identified based at least in part on a stored value of the property associated with a high willingness to commence a call. For example, if a stored value is geographic coordinates for a home of the user, the system may identify a criterion for a trigger condition that includes that the user be in an area determined based on the home geographic coordinates, in which the home location lies.

At a decision block 835, the system 300 determines whether to consider another property for a trigger condition. The system may make this determination in the ways discussed above with respect to block 840. If the system does determine to consider another property for a trigger condition, the process returns to block 810, and the system selects a property associated with the user. If the system determines to not consider another property for a trigger condition, the process 800 returns. In some implementations, the system determines to not consider another property for a trigger condition when all properties of a list of properties associated with the user have been considered. In some implementations, the system determines to not consider another property for a trigger condition when a predetermined number of trigger conditions have been identified. For example, the system may associate two trigger conditions with an intelligent reminder.

### CONCLUSION

The disclosed system and methods provide for an intelligent reminder for reminding a user to commence a call to a called party after a previous call to the called party has failed to connect. The system generates an alert to remind the user to call the called party, and it generates the alert under conditions that the disclosed system determines would be convenient for the user to commence a call to the called party.

The disclosed system and methods also provide for an intelligent reminder for reminding a user to commence a return call to a calling party after an incoming call initiated by the calling party has failed to connect with the user. The system generates an alert including an option to commence a return call to the calling party when it identifies conditions that the disclosed system determines are likely to be indicative of being convenient for the user to commence a return call to the calling party.

The disclosed system and method remind a user to call a called party based on geographic location information, a status of a device, scheduled events for a user, user behaviors, and the like.

Further details regarding the disclosed system and method may be found in commonly-assigned U.S. patent application Ser. No. [to be entered; attorney docket no. 8004US01], filed concurrently with the present application on Apr. 15, 2015, entitled SYSTEM AND METHOD FOR PROVIDING AN INTELLIGENT REMINDER FOR COMMENCING A RETURN LIVE COMMUNICATIONS SESSION, and commonly-assigned U.S. patent application Ser. No. [to be entered, attorney docket no. 8004US02], filed concurrently with the present application on Apr. 15, 2015, entitled SYSTEM AND METHOD FOR IDENTIFYING A TRIGGERING CONDITION FOR A REMINDER TO COMMENCE A LIVE COMMUNICATIONS SESSION, both of which are hereby incorporated herein by reference in their entireties.

Those skilled in the art will appreciate that the actual implementation of a data storage area may take a variety of forms, and the phrases “data storage” and “data storage area” are used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. A non-transitory computer-readable storage medium containing instructions for performing a method of initiating a call with a called party, the method comprising:
receiving from a user a request to establish a call with a called party;
commencing establishing a first call with the called party;
determining that the first call with the called party has failed to connect with the called party;
displaying, via a display device, an option to create an intelligent reminder for commencing another call with the called party;
receiving from the user a selection of the option to create an intelligent reminder for commencing another call with the called party;
identifying a trigger condition for the intelligent reminder;
wherein the trigger condition includes a criterion for generating an alert associated with the intelligent reminder;
causing the trigger condition to be associated with the intelligent reminder;
determining that the criterion for generating the alert has been met;
generating the alert associated with the intelligent reminder,
wherein the alert includes an option to commence establishing a call with the called party;
receiving from the user a selection of the option to commence establishing a call with the called party; and
commencing establishing a second call with the called party.

2. The non-transitory computer-readable storage medium of claim 1, wherein the criterion for generating the alert includes a property and a value associated with the property, and wherein the criterion is met when the value for the property is observed.

3. The non-transitory computer-readable storage medium of claim 1, wherein determining that the criterion for generating the alert has been met includes identifying that a mobile device of the user is within a predetermined distance of a predetermined geographic location.

4. The non-transitory computer-readable storage medium of claim 1, wherein determining that the criterion for generating the alert has been met includes identifying that a mobile device of the user is connected to a predetermined network.

5. The non-transitory computer-readable storage medium of claim 1, wherein determining that the criterion for generating the alert has been met includes determining that an event has concluded.

6. The non-transitory computer-readable storage medium of claim 1, wherein determining that the criterion for generating the alert has been met includes identifying a predetermined movement of a mobile device of the user.

7. The non-transitory computer-readable storage medium of claim 1, wherein the predetermined movement includes at least one of a route, a direction, a predicted destination, or a proximity to a destination.

8. The non-transitory computer-readable storage medium of claim 2, wherein identifying a trigger condition for the intelligent reminder includes selecting the value for the property based at least in part on a value for the property identified by a mobile device of the user when the user commenced a previous call.

9. The non-transitory computer-readable storage medium of claim 1, wherein identifying a trigger condition for the intelligent reminder includes identifying a trigger condition used for an intelligent reminder previously created for commencing a call to the called party.

10. The non-transitory computer-readable storage medium of claim 1, wherein identifying a trigger condition for the intelligent reminder includes identifying a trigger condition used for an intelligent reminder previously created for reminding the user to commence a call.

11. A method for initiating a call with a called party, the method performed by a computing system including a processor executing instructions stored in a memory, the method comprising:
receiving from a user a request to establish a call with a called party;
commencing establishing a first call with the called party;
determining that the first call with the called party has failed to connect with the called party;
displaying, via a display device, an option to create an intelligent reminder for commencing another call with the called party;
receiving from the user a selection of the option to create an intelligent reminder for commencing another call with the called party;
identifying a trigger condition for the intelligent reminder;
wherein the trigger condition includes a criterion for generating an alert associated with the intelligent reminder;
causing the trigger condition to be associated with the intelligent reminder;
determining that the criterion for generating the alert has been met;
generating the alert associated with the intelligent reminder,
wherein the alert includes an option to commence establishing a call with the called party;
receiving from the user a selection of the option to commence establishing a call with the called party; and
commencing establishing a second call with the called party.

12. The method of claim 11, wherein the criterion for generating the alert includes a property and a value associated with the property, and wherein the criterion is met when the value for the property is observed.

13. The method of claim 12, wherein identifying a trigger condition for the intelligent reminder includes selecting the value for the property based at least in part on a value for the property identified by a mobile device of the user when the user commenced an earlier call.

14. The method of claim 11, wherein determining that the criterion for generating the alert has been met includes identifying that a mobile device of the user is within a predetermined distance of a predetermined geographic location.

15. The method of claim 11, wherein determining that the criterion for generating the alert has been met includes determining that an event has concluded.

16. The method of claim 11, wherein determining that the criterion for generating the alert has been met includes identifying a predetermined movement of a mobile device of the user.

17. A system for initiating a call with a called party, the system including a processor and a memory, the method comprising:
means for receiving from a user a request to establish a call with a called party;
means for commencing establishing a first call with the called party;
means for determining that the first call with the called party has failed to connect with the called party;
means for displaying, via a display device, an option to create an intelligent reminder for commencing another call with the called party;
means for receiving from the user a selection of the option to create an intelligent reminder for commencing another call with the called party;
means for identifying a trigger condition for the intelligent reminder;
wherein the trigger condition includes a criterion for generating an alert associated with the intelligent reminder;
means for causing the trigger condition to be associated with the intelligent reminder;
means for determining that the criterion for generating the alert has been met;
means for generating the alert associated with the intelligent reminder,
wherein the alert includes an option, displayed via a display device, to commence establishing a call with the called party;
means for receiving from the user a selection of the option to commence establishing a call with the called party; and
means for commencing establishing a second call with the called party.

18. The system of claim 17, wherein the criterion for generating the alert includes a property and a value associated with the property, and wherein the criterion is met when the value for the property is observed.

19. The system of claim 17, wherein the means for identifying a trigger condition for the intelligent reminder includes means for selecting the value for the property based at least in part on a value for the property identified by a mobile device of the user when the user commenced an earlier call.

20. The system of claim 17, wherein the means for determining that the criterion for generating the alert has been met includes means for identifying that a mobile device of the user is within a predetermined distance of a predetermined geographic location.
